(19) United States
(12) Patent Application Publication
(10) Pub. No.: US 2007/0031559 A1
(43) Pub. Date: Feb. 8, 2007

(54) Low acrylamide food

(76) Inventors: Aharon M. Eyal, Jerusalem (IL); Asher Vitner, Jerusalem (IL); Ian C. Purtle, Plymouth, MN (US)

Correspondence Address: CARGILL, INCORPORATED, LAW/24, 15407 MCGINTY ROAD WEST, WAYZATA, MN, 55391, US

(21) Appl. No.: 11/501,552

(22) Filed: Aug. 9, 2006

(30) Foreign Application Priority Data
Feb. 9, 2005 (WO) US05/004196

(51) Int. Cl. A47J 39/00

(52) U.S. Cl. 426/520

(57) ABSTRACT

A method for preparing a heat-treated food from a raw ingredient derived from a plant material and containing asparagine and at least one reducing sugar is disclosed. The method includes contacting with the raw ingredient a reagent comprising an amino acid having a relatively low asparagine concentration so that a coating layer is formed. The method also includes heat treating such raw ingredient after such contacting or simultaneously with it. An oil for frying a raw ingredient from a plant material is also disclosed. A food product comprising a matrix of plant-based material having a reaction interface, and a layer at least partially covering the interface wherein the layer has undergone a Maillard reaction due to heat treatment is also disclosed. A food composition comprising a food at least partially coated with a reagent selected from the group consisting of an amino acid-containing compound, an amino acid salt, an amino acid amide, an amino acid ester, and mixtures thereof, provided that the amino acid is not asparagines is also disclosed. A method for preparing a coated food composition is also disclosed.

### CROSS-REFERENCE TO RELATED APPLICATIONS

The following patent applications are cross-referenced and are hereby incorporated by reference in their entirety: U.S. Patent Application No. 60/543,043, titled “ACRYLAMIDE REDUCTION SYSTEM” filed Feb. 9, 2004.

### FIELD OF THE INVENTION

The present invention generally relates to a low acrylamide food. The present invention more particularly relates to a system and method for forstalling or reducing the formation of acrylamide in foods prepared at elevated temperatures that undergo the Maillard reaction.

### BACKGROUND OF THE INVENTION

Acrylamide is found in food prepared at high temperature, such as French fries. Most scientists agree that acrylamide formation is a result of the reaction between asparagine and intermediates of Maillard reaction of reducing sugars. Several methods are known to reduce the occurrence of acrylamide in food that is heated (e.g. greater than about 140 degrees Celsius), including: (a) the addition of an accidulant (e.g. citric acid) to the food before heating; and (b) the addition of an antioxidant (e.g. vitamin E, vitamin C, beta carotene, etc.) to the food before heating. However, such known methods have several disadvantages including interfering with the Maillard reaction, thus interfering with generating the desired flavor, color and/or aroma of the food.

Accordingly, there is a need for a method for reducing the formation of acrylamide in heated food that provides for desirable flavor and color of the food. There is also a need for a method for reducing the formation of acrylamide in heated food that is adaptable to a variety of plant-based foods. It would be advantageous to provide a low acrylamide food and method filling any one or more of these needs or having other advantageous features.

### SUMMARY OF THE INVENTION

The present invention relates to a method for preparing a heat-treated food from a raw ingredient derived from a plant material and containing asparagine and at least one reducing sugar. The method includes contacting with the raw ingredient a reagent comprising an amino acid having a relatively low asparagine concentration so that a coating layer is formed. The method also includes heat treating such raw ingredient after such contacting or simultaneously with it.

The present invention also relates to a method for preparing a heat-treated food from a raw ingredient derived from a plant material and containing asparagine and at least one reducing sugar. The method includes contacting with the raw ingredient a reagent comprising an amino acid and having a relatively low concentration of asparagine. The method also includes subsequently heat treating the raw ingredient and

the reagent, wherein the step of contacting forms adjacent to a surface of the raw ingredient a coating layer containing the reagent at a concentration greater than about 100 ppm.

The present invention also relates to an oil for frying a raw ingredient from a plant material. The oil includes about 10 to about 50 ppm of at least one of an amino acid, amino acid fatty acid salt and derivatives thereof and has substantially no asparagine.

The present invention also relates to a food product comprising a matrix of plant-based material having a reaction interface, and a layer at least partially covering the interface wherein the layer has undergone a Maillard reaction due to heat treatment. The reaction layer is at least one of: (a) essentially free of acrylamide; and (b) has a reagent

concentration greater than an amino acid concentration of the matrix and wherein the reagent comprises a non-asparagine amino acid.

The present invention also relates to a food composition comprising a food at least partially coated with a reagent selected from the group consisting of an amino acid-containing compound, an amino acid salt, an amino acid amide, an amino acid ester, and mixtures thereof, provided that the amino acid is not asparagines.

The present invention also relates to a method for preparing a coated food composition. The method includes contacting a food, at least partially, with a reagent selected from the group consisting of an amino acid-containing compound, an amino acid salt, and amino acid amide, an amino acid ester, and mixtures thereof, provided that the amino acid is not asparagines.

### DETAILED DESCRIPTION

A method for reducing the formation of and/or concentration of acrylamide in a heated food. As used in this disclosure, the term “food” means and includes food or feed that physically nourishes or sustains, and includes products or consumables that are ingested for flavor. The term “heated food” as used in this disclosure means and includes food that is heated to the extent and for a sufficient duration to undergo the Maillard reaction.

The food starting material or raw ingredient comprises a substrate or matrix of plant-based material (e.g. a potato, coffee, cocoa, etc.) according to an exemplary embodiment. The matrix includes asparagine and a reducing sugar (e.g. dextrose, fructose, etc.) according to an exemplary embodiment. As used in this disclosure, the term “reducing sugar” means and includes reducing sugars, precursors thereof and reaction products thereof. For example, sucrose is not a reducing sugar according to the plain meaning, but since sucrose forms reducing sugars on hydrolysis it is a “reducing sugar” for purposes of this disclosure. According to a preferred embodiment, a reagent (e.g. amino acid excluding asparagine or having amino acids other than asparagine (“non-asparagine amino acid”) or derivatives thereof including salts, esters, etc.) is applied (e.g. by dipping) to an interface or exterior surface (which may include some penetration of the surface) of the food. The reagent forms a coating or layer on and/or in the exterior surface of the matrix according to a preferred embodiment. According to a preferred embodiment, the layer comprises a region in which the reducing sugar reacts with the reagent largely than it reacts with the asparagine (which such reaction may result in the formation of acrylamide).

In the resulting food product (i.e. food resulting from the food ingredient), the concentration of asparagine and/or the concentration of reducing sugar in this region or “reaction layer” also referred to as a coating, barrier area, surrounding layer, outer layer, surface layer, protection layer, sheath layer, and/or shielding layer is less than the concentration of the asparagine and/or the concentration of the reducing sugar in the matrix according to a preferred embodiment. According to a preferred embodiment, the reaction layer undergoes a Maillard reaction upon heating to a sufficiently high temperature and the resulting food product thereby has a palatable flavor, color (e.g. golden brown), and/or aroma.

According to a preferred embodiment, the resulting food product is substantially free of acrylamide. According to a preferred embodiment, the reaction layer of the resulting food product has a high concentration of the reagent (e.g. non-asparagine amino acid) relative to the concentration of asparagine in the matrix.

According to a preferred embodiment, the food ingredient is a raw potato. According to alternative embodiments, the food ingredient may be raw wheat, corn, soy, cocoa, coffee, flour, dough, etc., and products of processing thereof.

According to a preferred embodiment, the resulting food product is a heat-treated food. According to a particularly preferred embodiment, the resulting food product is a French fry. According to alternative embodiments, the resulting food product may be a potato chip, potato crisp, potato flake, bread, bakery product, tortilla, meat-replacer, roasted cocoa bean, roasted coffee bean, flavor ingredient, etc., and/or ingredients containing Maillard-reaction products.

According to a preferred embodiment, the concentration of the reagent applied to the food ingredient to form the reaction layer (e.g. as a solution) is at least about 100 ppm, preferably greater than about 500 ppm. According to a preferred embodiment, the equivalent concentration of the reagent of the reaction layer is greater than about 50 percent of the equivalent concentration of asparagine of the reaction layer. According to a particularly preferred embodiment, the water activity in the reaction layer is between about 0.3 and about 0.7.

According to a preferred embodiment, the reaction layer starts at the exterior surface of the matrix (or within about 1 millimeter from the exterior surface according to an alternative embodiment). According to a preferred embodiment, the volume of the reaction layer is less than about 50 percent of the volume of the matrix, more preferably less than about 20 percent of the volume of the matrix. According to a preferred embodiment, the average width of the reaction layer is less than about 5 mm, preferably less than about 1 mm. For example, a thickness of the reaction layer circumscribes or surrounds the matrix according to an exemplary embodiment.

According to a preferred embodiment, the reagent is applied to the matrix by dipping the food ingredient in a water and/or oil solution having the reagent. According to an alternative embodiment, the reagent is applied by spraying it on the exterior surface of the matrix (preferably sprayed after the food ingredients dipped in water or an aqueous solution.)

According to a preferred embodiment, the reagent comprises an a non-asparagine amino acid or derivative thereof and is of relatively low asparagines concentration, suitably less than about 10 percent, more suitably less than about 5 percent. Suitable reagents include amino acid-containing compounds and their derivatives, such as amino acid salts, amides, esters, peptides and proteins. Any non-asparagine amino acid may be suitable. According to a preferred embodiment, the amino acid is provided in aqueous solution. According to a preferred embodiment, the reagent includes amino acids that are present in free form in a relatively large amount in the matrix. According to a preferred embodiment, the reagent also carries an SH moiety.

According to a preferred embodiment, the reagent (e.g. non-asparagine amino acids and derivatives) is provided in oil and preferably has a relatively high solubility in oil. Oil with such reagents (i.e. non-asparagine amino acids and their derivative) provides for combining the reagent with the matrix simultaneously with heating (e.g. frying, roasting, baking, etc.) Exemplary reagents for association with the oil include cysteine, leucine, isoleucine, phenylalanine, tryptophan, methionine, other amino acids with five carbon atoms or more and salts of non-asparagine amino acids, esters, amides, and combinations thereof. According to a preferred embodiment, such salts include carboxylic acid salts, more preferably fatty acid salts.

According to an alterative embodiment, the reagent comprises peptides and/or proteins. Suitable peptides and/or proteins include those rich in basic amino acids, such as lysine, histidine and arginine. Soy proteins are also suitable according to a preferred embodiment, particularly soy proteins purified before use, such as protein concentrates and protein isolates. According to a preferred embodiment, such peptides and/or proteins are incorporated in the matrix during preparation of the raw ingredient (e.g. protein-containing dough). According to an alternative embodiment, the equivalent concentration of the free amino function of a protein (i.e. the reagent) is greater than about 50 percent of the equivalent concentration of asparagine in the reaction layer.

According to a preferred embodiment, the reagent (e.g. reagent solution) also contains a reducing sugar (e.g. dextrose, fructose, etc.), an antioxidant, a reducing agent, and/or a combination thereof. According to a preferred embodiment, the reagent is alkaline (e.g. includes a basic compound such as hydroxides, ammonia, bicarbonates or carbonates).

The food ingredient with the reaction layer is heated (e.g. heat treated) according to a preferred embodiment. According to a preferred embodiment, the food ingredient with the reaction layer is heated after treatment with the reagent or simultaneously with it. According to alternative embodiments, the food ingredient with the reaction layer may be heated (e.g. slightly) before treatment with the reagent. According to a preferred embodiment, the matrix with the reaction layer is heated to a temperature high enough and for sufficient duration to facilitate Maillard reactions between the reagent (e.g. non-asparagine amine-carrying compounds) and reducing sugars and/or other carbonyl-carrying compounds. According to a suitable embodiment, the matrix with the reaction layer is heated to a temperature greater than about 120 degrees Celsius, more preferably greater than about 140 degrees Celsius. Such heating could be conducted by means such as hot oil and various types of ovens as in frying, roasting and baking. According to an alternative embodiment, the food ingredient may be heated (e.g. slightly) before treatment with the reagent

According to a preferred embodiment, the matrix with the reaction layer is maintained for various periods, stored, or refrigerated before final heating. An exemplary embodiment for the preparation of blanched fries includes peeling potatoes, cutting them to strips or slices, addition of the reagent, blanching, and refrigeration. The blanched and refrigerated fries are suitable for frying or baking to yield the final product. According to an alternative embodiment, the reagent is provided in an oil and reagent incorporation or contacting and blanching may be conducted substantially simultaneously. According to another alternative embodiment for the preparation of blanched fries, the dipping of the matrix in a dextrose solution may be combined with reagent incorporation or done after it. According to an alternative embodiment, the blanched fries may be coated with a batter before frying.

According to an alternative embodiment, the reagent may be added to foods or products consumed primarily for flavor and/or aroma generated by the Maillard reaction (e.g. defatted cocoa, coffee, flavoring ingredients, sauces, etc.). According to this embodiment, the regent is preferably incorporated into the reaction layer of such products via an alkali solution (e.g. prior to or substantially simultaneously with heating). The reagent may be added to such products before or simultaneously with addition to the matrix of plant material according to alternative embodiments.

In yet another embodiment is provided a method for preparing a heat-treated food from a raw ingredient derived from a plant material and containing asparagine and at least one reducing sugar. The method can include the steps of contacting the raw ingredient with a reagent including an amino acid having a relatively low asparagine concentration so that a coating layer is formed and heat treating the raw ingredient and coating layer after such contacting or simultaneously with it. The heat treatment can be conducted using at least one of hot oil, hot water, steam, hot air, and ovens and can also be conducted after the step of contacting or substantially simultaneously with it.

The reagent used in this method can contain an SH moiety or at least one of a lysine-rich protein, histidine-rich protein and arginine-rich protein.

The coating layer produced by this method can include starch and protein, such as purified soy protein. The protein can include at least about 10 percent of the raw ingredient. In some instances, the volume of the coating layer is less than about 50 percent of the volume of the food ingredient and the average width of the coating layer is less than about 5 millimeters. Additionally, water activity in the coating layer can be in the range between about 0.3 and about 0.7. Further, the equivalent concentration of the reagent in the coating layer can be greater than about 50 percent of the equivalent concentration of asparagine in the coating layer. According to one method, the reagent is provided via a solvent, the solvent including at least one of water and oil. Thus, in one instance, the solvent is oil and the amino-acid reagent includes at least one of amino acids comprising 5 carbon atoms or more and a fatty acid salt of an amino acid. The solvent can be alkaline and also include an antioxidant or a reducing agent.

In another method for preparing a heat-treated food, raw ingredient derived from a plant material such as cocoa and coffee beans and containing asparagine and at least one reducing sugar, is contacted a reagent having an amino acid and relatively low concentration of asparagines. The raw ingredient can be subsequently heat treated. The raw ingredient is heated to a temperature greater than about 120 degrees and the reagent is provided in an oil for heating the raw ingredient to a temperature greater than about 120 degrees Celsius. In one embodiment, the step of contacting forms coating layer adjacent to a surface of the raw ingredient that contains the reagent at a concentration greater than about 100 ppm. The method of claim 26 wherein the reagent is provided via an alkali solution.

In yet another embodiment, the present invention provides a food product having a matrix of plant-based material with a reaction interface and a layer at least partially covering the interface wherein the layer has undergone a Maillard reaction due to heat treatment. Further, the layer is at least essentially free of acrylamide or has a reagent concentration greater than an amino acid concentration of the matrix and wherein the reagent comprises a non-asparagine amino acid.

In still another embodiment is a method for preparing a coated food composition that includes the steps of contacting a food, at least partially, with a reagent selected from the group consisting of an amino acid-containing compound, an amino acid salt, and amino acid amide, an amino acid ester, and mixtures thereof, provided that the amino acid is not asparagines. This method can further include heating the at least partially coated food.

While the preferred and other exemplary embodiments described in this disclosure are presently preferred, it should be understood that these embodiments are offered by way of example only. The invention is not limited to a particular embodiment, but extends to various modifications, combinations, and permutations.

What is claimed is:

1. A method for preparing a heat-treated food from a raw ingredient derived from a plant material and containing asparagine and at least one reducing sugar comprising the steps of:
contacting the raw ingredient with a reagent including an amino acid having a relatively low asparagine concentration so that a coating layer is formed; and
heat treating the raw ingredient and coating layer after such contacting or simultaneously with it.

2. The method of claim 1 wherein the raw ingredient comprises at least one of potatoes, wheat, corn, soy, cocoa, defatted cocoa, coffee, flour, dough, and products of processing thereof.

3. The method of claim 1 wherein the heat-treated food comprises at least one of French fries, potato chips, potato crisps, bread, bakery products, tortilla, meat-replacers, roasted defatted cocoa beans, roasted coffee beans and ingredients containing Maillard-reaction products.

4. The method of claim 1 wherein the reagent comprises at least one of lysine, cysteine, leucine, isoleucine, phenylalanine, tryptophan, methionine, and their derivatives.

5. The method of claim 7 wherein the contacting comprises at least one of dipping, spraying, spreading, coating the composition including the reagent on the raw ingredient, or a combination thereof.

6. The method of claim 7 wherein the heat treatment is to a temperature greater than about 120 degrees Celsius.

7. The method of claim 20 wherein the heat treatment has a temperature and duration sufficient to facilitate the participation of at least a fraction of the reagent in the coating layer in a Maillard reaction with reducing sugar present in the coating layer.

8. The method of claim 22 wherein the heat treatment further comprises two heating stages.

9. The method of claim 22 wherein the heat treatment further comprises the step of storing the raw ingredient between two heating stages.

10. A heat treated food made by the method of claim 1.
